(19) United States
(12) Patent Application Publication
(10) Pub. No.: US 2021/0134021 A1
(43) Pub. Date: May 6, 2021

(54) DISPLAY SYSTEM AND DISPLAY METHOD

(71) Applicant: PANASONIC INTELLECTUAL PROPERTY MANAGEMENT CO., LTD., Osaka (JP)

(72) Inventor: Shintaro YOSHIKUNI, Fukuoka (JP)

(73) Assignee: PANASONIC INTELLECTUAL PROPERTY MANAGEMENT CO., LTD., Osaka (JP)

(21) Appl. No.: 17/085,229

(22) Filed: Oct. 30, 2020

(30) Foreign Application Priority Data
Oct. 31, 2019 (JP) 2019-199163

(51) Int. Cl. G06T 11/00; G06F 3/14; H04N 5/272; H04N 5/232; H04R 1/40; H04R 3/00; G10L 25/51

(52) U.S. Cl. CPC G06T 11/00; G06F 3/14; H04N 5/272; H04R 2499/15; H04R 1/406; H04R 3/005; G10L 25/51; H04N 5/23299

(57) ABSTRACT

A display system for displaying a sound source includes a microphone array configured to pick up a sound of the sound source, a display device a memory that stores instructions, and a processor that, when executing the instructions stored in the memory, performs a process. The process includes: processing a signal of the sound of the sound source picked up by the microphone array, visualizing the sound of the sound source picked up by the microphone array, determining a position of the sound source using data of the visualized sound of the sound source, generating an image indicating the position of the sound source, and displaying a direction of the position of the sound source on the display device when the position of the sound source indicated by the image is located outside a display range of the display device.

### BACKGROUND OF THE INVENTION

### 1. Field of the Invention

The present disclosure relates to a display system and a display method for displaying a sound source.

### 2. Description of the Related Art

A sound source display method is known which performs a sound source display operation by shooting a monitoring area with a camera, picking up a sound in the monitoring area with a microphone array, and superimposing sound source image information indicating a sound source determined by the microphone array on image data of the monitoring area (refer to JP-A-2018-101987, for example).

However, in general, a shooting range of a camera and a sound pickup range do not coincide with each other, that is, in most cases the latter is wider than the former ((camera shooting range)<(sound pickup range)). Thus, in the above sound source display method disclosed in JP-A-2018-101987, a sound source located outside the shooting range of the camera cannot be displayed. As a result, when a sound has occurred outside the shooting range of the camera, a surveillant cannot find a sound source easily and hence it is difficult to monitor the sound source. If a sound that has occurred outside the shooting range of the camera is very weak, the surveillant cannot even recognize the sound.

### SUMMARY OF THE INVENTION

The concept of the present disclosure has been conceived in view of the above circumstances in the art, and an object of the disclosure is therefore to provide a display system and a display method for a sound source which, even when a sound source has occurred outside the shooting range of a camera, can display the sound source and allow a surveillant to find the sound source easily by determining the sound source and displaying a direction of the sound source at an end portion of the display range of a display device.

The disclosure provides a display system for displaying a sound source, includes a microphone array configured to pick up a sound of the sound source, a display device a memory that stores instructions, and a processor that, when executing the instructions stored in the memory, performs a process. The process includes: processing a signal of the sound of the sound source picked up by the microphone array, visualizing the sound of the sound source picked up by the microphone array, determining a position of the sound source using data of the visualized sound of the sound source, generating an image indicating the position of the sound source, and displaying a direction of the position of the sound source on the display device when the position of the sound source indicated by the image is located outside a display range of the display device.

The disclosure also provides a display method including: processing a signal of a sound of a sound source picked up by a microphone array, visualizing the sound of the sound source based on the signal of the sound, determining a position of the sound source using data of the visualized sound of the sound source, generating an image indicating the position of the sound source, and displaying a direction of the position of the sound source on a display device when the position of the sound source indicated by the image is located outside a display range of the display device.

Even when a sound source has occurred outside the shooting range of a camera, the disclosure makes it possible to display the sound source and allows a surveillant to find the sound source easily by determining the sound source and displaying a sound source direction at an end portion of the display range of a display device.

### BRIEF DESCRIPTION OF DRAWINGS

FIG. 1 is a diagram showing a general configuration of a sound source display system according to embodiments;

FIG. 2 is a block diagram showing a detailed configuration of a sound source display system according to a first embodiment;

FIG. 3 is a diagram illustrating an example of how a sound source is displayed in the sound source display system according to the first embodiment;

FIG. 4 is an operation flowchart of the sound source display system according to the first embodiment;

FIG. 5 is a block diagram showing a detailed configuration of a sound source display apparatus according to a second embodiment;

FIG. 6 is a diagram illustrating an example of how a sound source is displayed in the sound source display apparatus according to the second embodiment; and

FIG. 7 is an operation flowchart of the sound source display apparatus according to the second embodiment.

### DETAILED DESCRIPTION OF THE EXEMPLARY EMBODIMENTS

Embodiment as specific disclosures of a display system and a display method for a sound source according to the present disclosure will be described in detail by referring to the drawings when necessary. However, unnecessarily detailed descriptions may be avoided. For example, detailed descriptions of already well-known items and duplicated descriptions of constituent elements having substantially the same ones already described may be omitted. This is to prevent the following description from becoming unnecessarily redundant and thereby facilitate understanding of those skilled in the art. The following description and the accompanying drawings are provided to allow those skilled in the art to understand the disclosure thoroughly and are not intended to restrict the subject matter set forth in the claims. The following embodiments will be directed to sound source image generation apparatus including a sound source display system.

### Embodiment 1

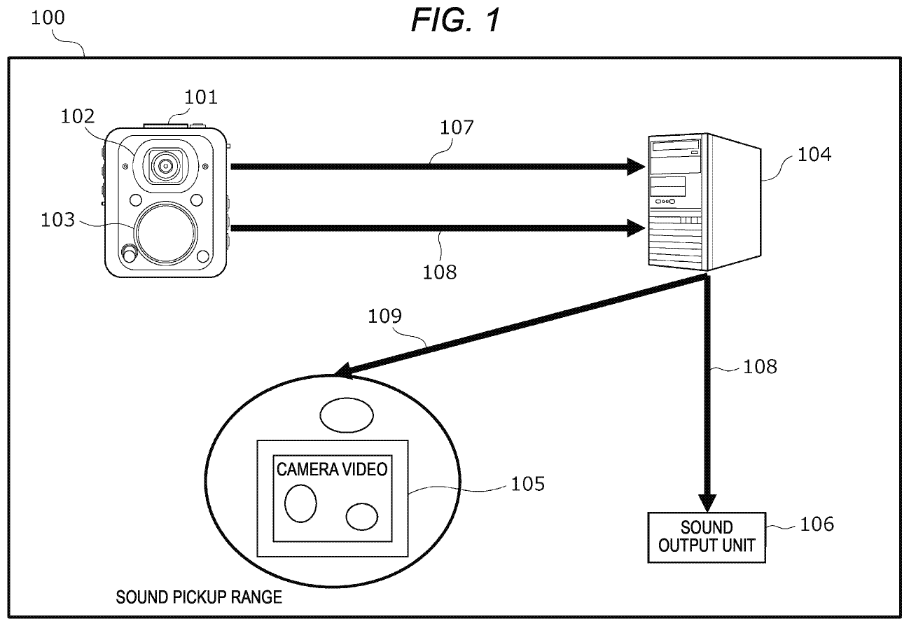

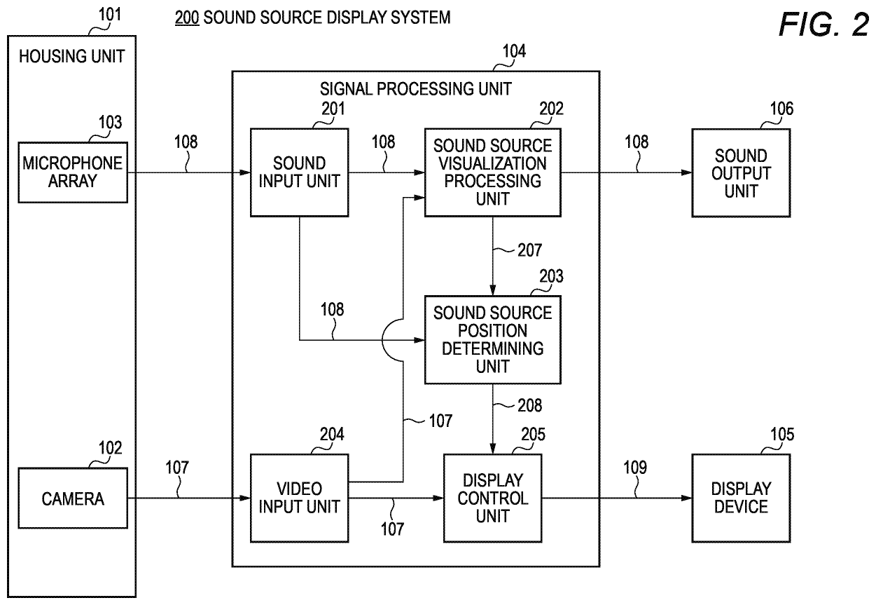

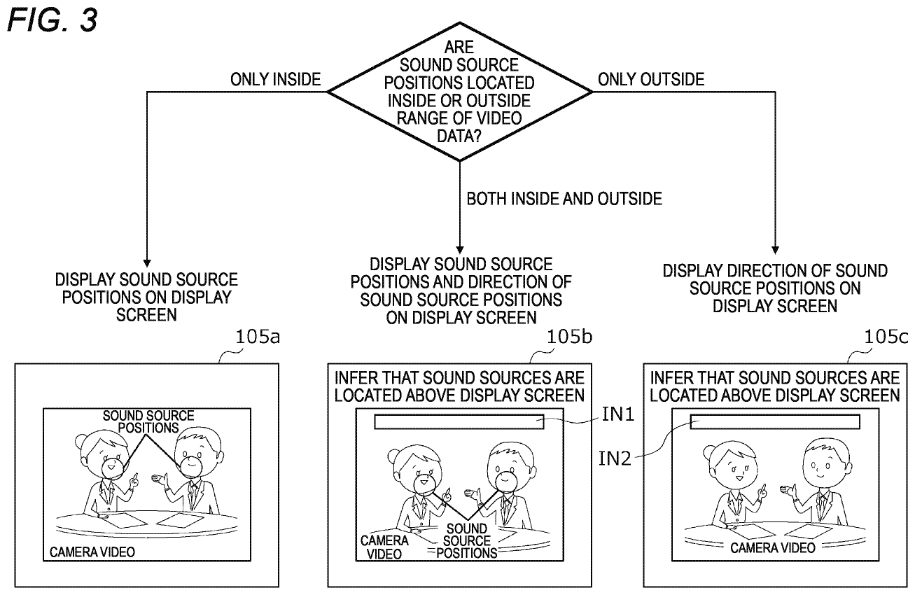

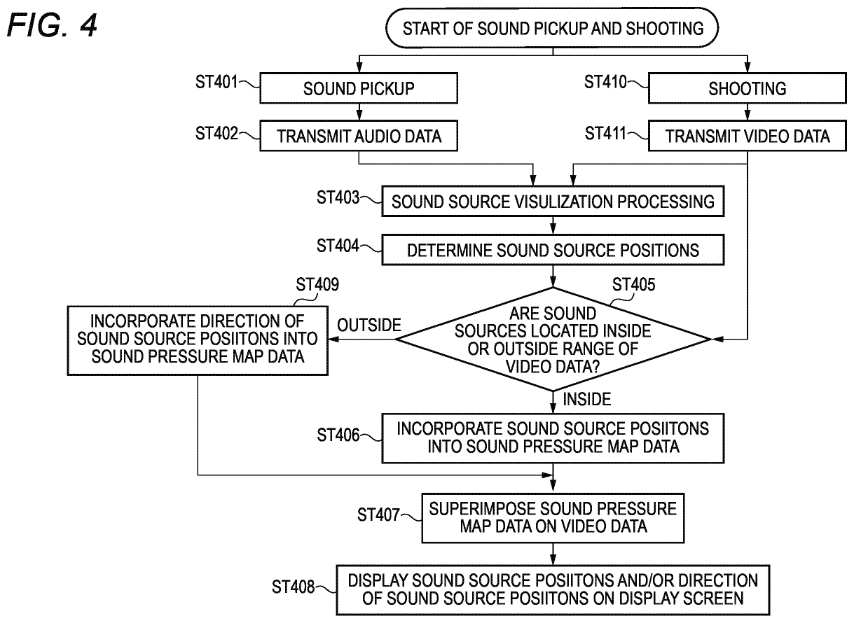

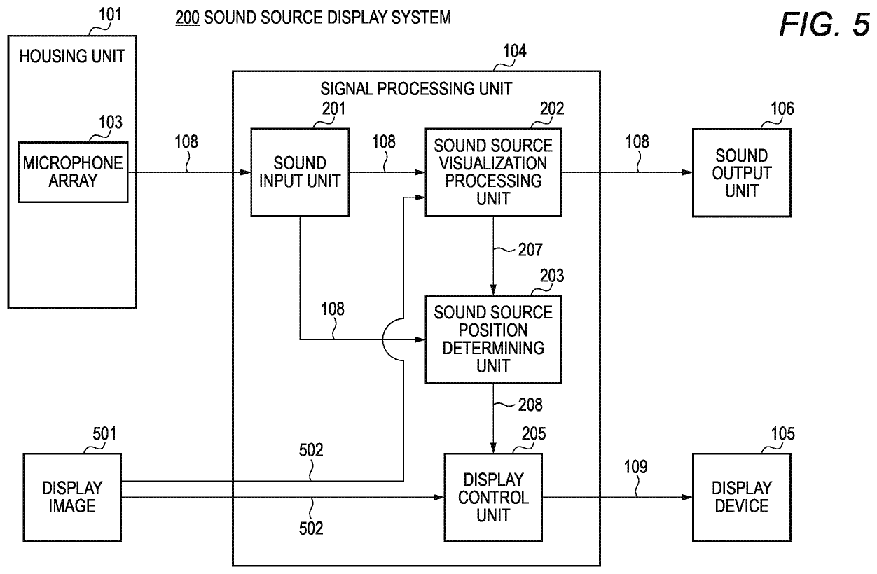

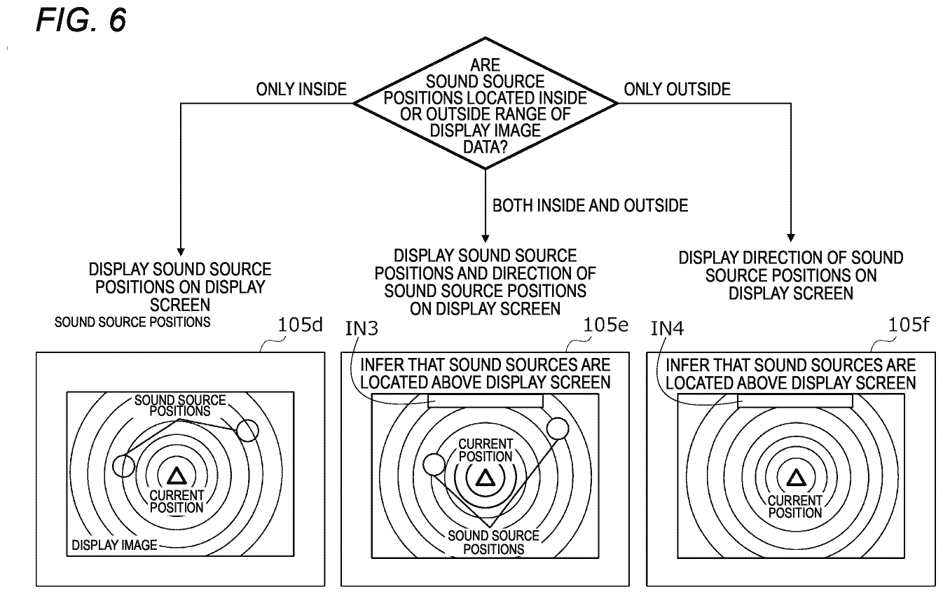

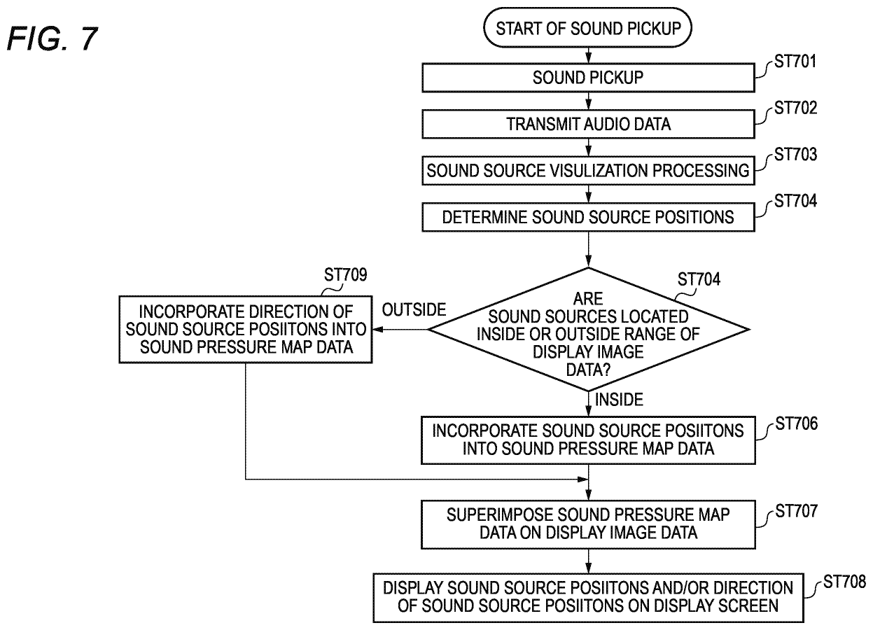

FIG. 1 is a diagram showing a general configuration of a sound source display system 100 according to embodiments. FIG. 2 is a block diagram showing a detailed configuration of a sound source display system 200 according to a first embodiment. FIG. 3 is a diagram illustrating an example of how a sound source is displayed in the sound source display system 200 according to the first embodiment. FIG. 4 is an operation flowchart of the sound source display system 200 according to the first embodiment. FIG. 5 is a block diagram showing a detailed configuration of a sound source display apparatus 500 according to a second embodiment. FIG. 6 is a diagram illustrating an example of how a sound source is displayed in the sound source display apparatus 500 according to the second embodiment. FIG. 7 is an operation flowchart of the sound source display apparatus 500 according to the second embodiment.

The sound source display system 100 shown in FIG. 1 includes a housing unit 101, a signal processing device 104, a display device 105, and a sound output unit 106. The housing unit 101 includes a camera 102, and a microphone array 103.

The housing unit 101, which is a terminal that houses the camera 102 and the microphone array 103, holds the camera 102 and the microphone array 103 so that the shooting direction of the camera 102 and the sound pickup direction of the microphone array 103 are approximately the same. The housing unit 101 is a portable terminal that a user of the housing unit 101 can wear or carry easily and is, for example, a wearable camera (BWC: body-worn camera). The housing unit 101 serves as a unit of a sound source display system or a sound source display apparatus.

The camera 102 shoots a monitoring target area (shooting area) where the housing unit 101 having the camera 102 is provided and transmits video data 107 of the area to the signal processing device 104. The camera 102 may be either a 360° camera (in other words, omnidirectional camera) or a camera that is rotated in the pan direction or tilt direction.

The microphone array 103 picks up a sound in the monitoring target area (sound pickup area) where the housing unit 101 having the microphone array 103 is provided and transmits audio data 108 of the area to the signal processing device 104. Plural microphones may be arranged to constitute the microphone array 103.

In the sound source display system 100, the camera 102 and the microphone array 103 may be installed in different bodies. However, to allow the microphone array 103 to pick up a sound occurring in the shooting area of the camera 102 and enable determination of sound source positions, for example, as shown in FIG. 1 the camera 102 and the microphone array 103 be arranged adjacent to each other and housed in the housing unit 101 in such a manner that the shooting direction of the camera 102 and the sound pickup direction of the microphone array 103 are approximately the same.

The signal processing device 104 is a computer such as a PC (personal computer). The signal processing device 104 performs various kinds of signal processing using audio data 108 acquired from the microphone array 103 and video data 107 acquired from the camera 102, generates display image data 109 in which sound source positions are added to the video data 107, and transmits the generated display image data 109 to the display device 105. Furthermore, the signal processing device 104 transmits the audio data 108 to the sound output unit 106. Although in the sound source display system 100 the signal processing device 104 and the housing unit 101 are separate from each other, the signal processing device 104 and the housing unit 101 may be integrated with each other in which case the internal configuration of the signal processing device 104 may be incorporated in the housing unit 101.

The display device 105, which is a display device such as an LCD (liquid crystal display) or an organic EL (electroluminescence) display, displays display image data 109 acquired by the signal processing device 104 on the screen. More specifically, the display device 105 displays the display image data 109 on the screen of a display device such as a monitor.

The sound output unit 106, which is, for example, a speaker, outputs a sound of audio data 108 acquired from the signal processing device 104. More specifically, the sound output unit 106 outputs a sound of audio data 108 acquired from the signal processing device 104 by converting the audio data 108 into an audio signal. Communication of data between the individual units of the sound source display system 100 may be performed either via wired or wireless interfaces or in the form of a network communication using a cloud or the like.

The sound source display system 200 shown in FIG. 2 is an example of the sound source display system 100 according to the first embodiment and includes a housing unit 101, a signal processing device 104, a display device 105, and a sound output unit 106. Since the housing unit 101, the display device 105, and the sound output unit 106 are the same as those shown in FIG. 1 and hence will not be described. The signal processing device 104 includes a sound input unit 201, a sound source visualization processing unit 202, a sound source position determining unit 203, a video input unit 204, and a display control unit 205.

The sound input unit 201 is an interface for sending audio data 108 acquired by the microphone array 103 to the sound source visualization processing unit 202 and the sound source position determining unit 203.

The video input unit 204 is an interface for sending video data 107 taken by the camera 102 to the sound source visualization processing unit 202 and the display control unit 205.

The sound source visualization processing unit 202 generates visualization data 207 which is sound pressure map data obtained by assigning, to each of plural pixels of plural image data constituting the video data 107, a sound pressure calculation value at the position of the pixel, on the basis of sets of coordinates indicating positions in the video data 107 acquired from the video input unit 204 and the audio data 108 acquired from the sound input unit 201, and sends the generated visualization data 207 to the sound source position determining unit 203. Furthermore, the sound source visualization processing unit 202 transmits the audio data 108 to the sound output unit 106.

The sound source position determining unit 203 holds, in advance, as a threshold value, an expected value of a sound pressure to be generated from a sound source in a monitoring target area. The sound source position determining unit 203 generates sound source position data 208 in which positions of pixels at which the sound pressure value of the visualization data 207 (sound pressure map data) is larger than the above-mentioned threshold value are employed as sound source positions on the basis of the audio data 108 and the visualization data 207, and sends the generated sound source position data 208 to the display control unit 205. The sound source position data 208 may be data in which only the pixels at which the sound pressure calculation value is larger than the threshold value are selected in the visualization data 207 (sound pressure map data). Alternatively, the sound source position data 208 may be the whole of the sound pressure map data including the pixels at which the sound pressure calculation value is larger than the threshold value in the visualization data 207 (sound pressure map data).

The display control unit 205 judges whether the sound source positions are located inside or outside the range of the video data 107 and transmits, to the display device 105, display information that is suitable for each case. More specifically, the display control unit 205 transmits information for causing display of a sound source position if it is located within the range of the video data 107 and transmits information for causing display of a direction of a sound source position if it is located outside the range of the video data 107. In the first embodiment, the display control unit 205 transmits display image data 109 as processed according to the sets of coordinates of the sound pressure map data by superimposing the sound source position data 208 on the video data 107 acquired from the video input unit 204.

Next, a sound source position display method according to the first embodiment will be described with reference to FIG. 3. The display control unit 205 judges whether sound source positions are located inside or outside the range of video data 107. If all of the sound source positions are located inside the range of the video data 107, a heat map of the sound source positions are displayed on the display screen of the display device 105 (denoted by symbol 105a). If all of the sound source positions are located outside the range of the video data 107, an indicator IN2 indicating a direction of the sound source positions is displayed on the display screen of the display device 105 (denoted by symbol 105c). If the sound source positions are located both inside and outside the range of the video data 107, a heat map of sound source positions are displayed on the display screen of the display device 105 and, furthermore, an indicator IN1 indicating a direction of sound source positions is displayed on the display screen of the display device 105 (denoted by symbol 105b). In the first embodiment, the direction of sound source positions is judged upward and hence displayed at a top end portion of the display screen. Although in the first embodiment a direction of sound source positions is displayed if the sound source positions are located outside the range of the video data 107, the display position of a direction of sound source positions is not limited to an end portion of the display screen and may be any portion of the display screen. The display control unit 205 may display a direction of sound source positions on an edge portion of the display device 105, for example, a frame of the display device 105. More specifically, optical elements such as LEDs are provided on the frame of the display device 105 and an indicator IN1 or IN2 indicating a direction of sound source positions is displayed by causing the optical elements to light or blink.

Next, how the sound source display system 200 according to the first embodiment operates will be described with reference to FIG. 4.

Upon a start of operation of the sound source display system 200, shooting by the camera 102 and sound pickup by the microphone array 103 are started at the same time. At step ST410, the camera 102 shoots a shooting area that is a monitoring target and transmits resulting video data 107 to the video input unit 204. When receiving the video data 107, at step ST411 the video input unit 204 converts the video data 107 into data having such a form as to be suitable for visualization processing and sends the resulting data to the sound source visualization processing unit 202. At step ST401, the microphone array 103 picks up a sound generated in the sound pickup area that is a monitoring target and transmits resulting audio data 108 to the sound input unit 201. At step ST402, the sound input unit 201 converts the received audio data 108 into data having such a form as to be suitable for sound source visualization processing and sends the resulting data to the sound source visualization processing unit 202. At step ST403, the sound source visualization processing unit 202 generates visualization data 207 (sound pressure map data) on the basis of the audio data 108 and the video data 107 and sends the generated visualization data 207 to the sound source position determining unit 203.

At step ST404, the sound source position determining unit 203 generates sound source position data 208 in which sound source positions in the sound pressure map data are determined on the basis of the audio data 108 and the visualization data 207 and sends the generated sound source position data 208 to the display control unit 205.

At step ST405, the display control unit 205 judges whether the sound source positions are located inside or outside the range of the video data 107 on the basis of the sound source position data 208 and the video data 107. If judging that all of the sound source positions are located inside the range of the video data 107, the display control unit 205 incorporates the sound source positions that are based on the sound source position data 208 into the sound pressure map data at step ST406, superimposes the resulting sound pressure map data on the video data 107 at step ST407, and displays the sound source positions on the display screen in the form of a heat map at step ST408.

If judging that all of the sound source positions are located outside the range of the video data 107, the display control unit 205 incorporates a direction of the sound source positions that are based on the sound source position data 208 into the sound pressure map data at step ST409, superimposes the resulting sound pressure map data on the video data 107 at step ST407, and displays the direction of the sound source positions on the display screen at step ST408.

If judging that the sound source positions are located both inside and outside the range of the video data 107, the display control unit 205 incorporates sound source positions that are based on the sound source position data 208 and a direction of sound source positions that are based on the sound source position data 208 into the sound pressure map data at steps ST406 and ST409, superimposes the resulting sound pressure map data on the video data 107 at step ST407, and displays the sound source positions on the display screen in the form of a heat map and also displays the direction of the sound source positions on the display screen at step ST408.

Configured as described above, even when a sound source has occurred outside the shooting range of the camera 102, the sound source display system 200 can indicate a direction of the sound source located outside the shooting range of the camera 102 by determining the sound source and displaying the direction of a sound source position on the display screen and allows a surveillant to find the sound source position easily, thereby increasing the visibility of the user. In other words, the sound source display system 200 can indicate a direction of a position of a sound source located outside the display range of a display image. This allows the surveillant to find the sound source position easily. Furthermore, even if a sound source that has occurred outside the display range of the display device 105 is so weak as not to be recognized by a surveillant, the surveillant can find a direction of a position of the sound source in the case where the sound is a monitoring target sound by displaying a direction of the sound source position, whereby the visibility of the user can be increased.

### Embodiment 2

A sound source display apparatus 500 according to a second embodiment shown in FIG. 5 includes a housing unit 101, a signal processing device 104, a display device 105, a sound output unit 106, and a display image 501. Since the configuration of the sound source display apparatus 500 according to the second embodiment is obtained by removing the camera 102 and the video input unit 204 from the configuration of the sound source display system 200 according to the first embodiment and adding the display image 501 to the latter and hence the individual units will not be described. In the second embodiment, display image data 502 that is prepared in advance as display image 501 is used in place of video data 107 that is used in the first embodiment.

Next, a sound source position display method according to the second embodiment will be described with reference to FIG. 6. The display control unit 205 judges whether sound source positions are located inside or outside the range of the display image data 502. If all of the sound source positions are located inside the range of the display image data 502, a heat map of the sound source positions are displayed on the display screen of the display device 105 (denoted by symbol 105d). If all of the sound source positions are located outside the range of the display image data 502, an indicator IN4 indicating a direction of the sound source positions is displayed on the display screen of the display device 105 (denoted by symbol 105f). If the sound source positions are located both inside and outside the range of the display image data 502, a heat map of sound source positions are displayed on the display screen of the display device 105 and, furthermore, an indicator IN3 indicating a direction of sound source positions is displayed on the display screen of the display device 105 (denoted by symbol 105e). In the second embodiment, the direction of sound source positions is judged upward and hence displayed at a top end portion of the display screen. Although in the second embodiment a direction of sound source positions is displayed if the sound source positions are located outside the range of the display image data 502, the display position of a direction of sound source positions is not limited to an end portion of the display screen and may be any portion of the display screen. The display control unit 205 may display a direction of sound source positions on the frame of the display device 105. More specifically, optical elements such as LEDs are provided on the frame of the display device 105 and an indicator IN3 or IN4 indicating a direction of sound source positions is displayed by causing the optical elements to light or blink.

Next, how the sound source display apparatus 500 according to the second embodiment operates will be described with reference to FIG. 7.

In the sound source display apparatus 500, at step ST701, the microphone array 103 picks up a sound generated in the sound pickup area that is a monitoring target and transmits resulting audio data 108 to the sound input unit 201. At step ST702, the sound input unit 201 converts the received audio data 108 into data having such a form as to be suitable for sound source visualization processing and sends the resulting data to the sound source visualization processing unit 202. At step ST703, the sound source visualization processing unit 202 generates visualization data 207 (sound pressure map data) on the basis of the audio data 108 and the display image data 502 obtained from the display image 501 prepared in advance and sends the generated visualization data 207 to the sound source position determining unit 203.

At step ST704, the sound source position determining unit 203 generates sound source position data 208 in which sound source positions in the sound pressure map data are determined on the basis of the audio data 108 and the visualization data 207 and sends the generated sound source position data 208 to the display control unit 205.

At step ST705, the display control unit 205 judges whether the sound source positions are located inside or outside the range of the display image data 502 on the basis of the sound source position data 208 and the display image data 502. Ifjudging that all of the sound source positions are located inside the range of the display image data 502, the display control unit 205 incorporates the sound source positions that are based on the sound source position data 208 into the sound pressure map data at step ST706, superimposes the resulting sound pressure map data on the display image data 502 at step ST707, and displays the sound source positions on the display screen in the form of a heat map at step ST708.

If judging that all of the sound source positions are located outside the range of the display image data 502, the display control unit 205 incorporates a direction of the sound source positions that are based on the sound source position data 208 into the sound pressure map data at step ST709, superimposes the resulting sound pressure map data on the video data 107 at step ST707, and displays the direction of the sound source positions on the display screen at step ST708.

If judging that the sound source positions are located both inside and outside the range of the display image data 502, the display control unit 205 incorporates sound source positions that are based on the sound source position data 208 and a direction of sound source positions that are based on the sound source position data 208 into the sound pressure map data at steps ST706 and ST709, superimposes the resulting sound pressure map data on the display image data 502 at step ST707, and displays the sound source positions on the display screen in the form of a heat map and also displays the direction of the sound source positions on the display screen at step ST708.

Configured as described above, even when a sound source has occurred outside the shooting range of the camera 102, the sound source display apparatus 500 can indicate a direction of the sound source located outside the shooting range of the camera 102 by determining the sound source and displaying the direction of a sound source position on the display screen and allows a surveillant to find the sound source position easily, thereby increasing the visibility of the user.

As described above, a sound source display system according to a first aspect of the disclosure is equipped with a signal processing device which generates an image on the basis of a sound of a sound source picked up by a microphone array and a display device which displays the image generated by the signal processing device. The signal processing device is characterized by being equipped with a sound source visualization processing unit which performs sound source visualization processing on the basis of the sound of the sound source picked up by the microphone array, a sound source position determining unit which determines a sound source position on the basis of visualization data generated by the visualization processing of the sound source visualization processing unit, and a display control unit which generates an image indicating the sound source position determined by the sound source position determining unit and generates display information indicating a direction of the sound source position if the sound source position indicated by the generated image is located outside a display range of the display device. With this configuration, the sound display system provides an advantage that even if a determined sound source is located outside the display range of the display device, a direction of a position of the sound source can be indicated by displaying the direction of the sound source position on the display device.

The sound source display system according to the first aspect of the disclosure is further characterized in that the display information serves to display the direction of the sound source position in the display range of the display device. With this measure, the sound source display system provides an advantage that even if a determined sound source is located outside the display range of the display device, a direction of a position of the sound source can be indicated by displaying the direction of the sound source position in the display range of the display device.

The sound source display system according to the first aspect of the disclosure is further characterized in that the display information serves to display the direction of the sound source position at an end portion of the display range of the display device. With this measure, the sound source display system provides an advantage that even if a determined sound source is located outside the display range of the display device, a direction of a position of the sound source can be indicated by displaying the direction of the sound source position at the end portion of the display device.

The sound source display system according to the first aspect of the disclosure is further characterized in that the display information serves to display the direction of the sound source position on a frame of the display range of the display device. With this measure, the sound source display system provides an advantage that even if a determined sound source is located outside the display range of the display device, a direction of a position of the sound source can be indicated by displaying the direction of the sound source position on the frame of the display device.

The sound source display system according to the first aspect of the disclosure is further characterized in that the sound source position determining unit determines a sound source position only if a volume of the sound source is larger than a prescribed threshold value. With this measure, the sound source display system provides an advantage that generation of noise can be suppressed and hence a sound source position can be determined more correctly.

The sound source display system according to the first aspect of the disclosure is further characterized in that the sound source position determining unit determines a sound source position only if a sound of the sound source is recognized as a human voice. With this measure, the sound source display system provides advantages that lowering of the accuracy of determination of a sound source position due to generation of noise can be prevented and the efficiency of determination of a sound source position can be increased.

A sound source display system according to a second aspect of the disclosure is characterized by being equipped with a microphone array which picks up a sound of a sound source, a sound source visualization processing unit which performs sound source visualization processing on the basis of the sound of the sound source picked up by the microphone array, a sound source position determining unit which determines a sound source position on the basis of visualization data generated by the visualization processing of the sound source visualization processing unit, a display control unit which generates an image indicating the sound source position determined by the sound source position determining unit, and a display device which displays the image generated by the display control unit, and further characterized in that the display control unit which generates display information indicating a direction of the sound source position if the sound source position determined by the sound source position determining unit is located outside a display range of the display device. With this configuration, the sound source display system provides advantages that even if a determined sound source is located outside the display range of the display device, a direction of a position of the sound source can be indicated by displaying the direction of the sound source position on the display device.

The sound source display system according to the second aspect of the disclosure is further characterized in that the display information serves to display the direction of the sound source position in the display range of the display device. With this measure, the sound source display system provides an advantage that even if a determined sound source is located outside the display range of the display device, a direction of a position of the sound source can be indicated by displaying the direction of the sound source position in the display range of the display device.

The sound source display system according to the second aspect of the disclosure is further characterized in that the display information serves to display the direction of the sound source position at an end portion of the display range of the display device. With this measure, the sound source display system provides an advantage that even if a determined sound source is located outside the display range of the display device, a direction of a position of the sound source can be indicated by displaying the direction of the sound source position at the end portion of the display range of the display device.

The sound source display system according to the second aspect of the disclosure is further characterized in that the display information serves to display the direction of the sound source position on a frame of the display range of the display device. With this measure, the sound source display system provides an advantage that even if a determined sound source is located outside the display range of the display device, a direction of a position of the sound source can be indicated by displaying the direction of the sound source position on the frame of the display device.

The sound source display system according to the second aspect of the disclosure is further characterized by being further equipped with a camera which takes a video. With this measure, the sound source display system provides an advantage that a sound source position can be displayed in a video taken by the camera by superimposing a sound source position on the video taken.

The sound source display system according to the second aspect of the disclosure is further characterized in that the camera is rotated vertically and horizontally. With this measure, the sound source display system provides an advantage that the camera can be rotated to a displayed direction of a sound source that has occurred outside the display range of the display device and shoot the sound source located there.

The sound source display system according to the second aspect of the disclosure is further characterized in that the camera is rotated automatically to such a direction as to be able to shoot the sound source if a sound source position determined by the sound source position determining unit is located outside the display range of the display device. With this measure, the sound source display system provides an advantage that a sound source position can be determined easily because the camera is rotated automatically to a displayed direction of a sound source position that has occurred outside the display range of the display device.

Although the various embodiments have been described above with reference to the drawings, it goes without saying that the concept of the disclosure is not limited to those examples. It is apparent that those skilled in the art could conceive various changes or modifications within the confines of the claims. And such changes or modifications should naturally be construed as being included in the technical scope of the disclosure.

The present application is based on Japanese Patent Application No. 2019-199163 filed on Oct. 31, 2019, the contents of which are incorporated herein by reference.

The disclosure is useful in providing a sound source display system and sound source display apparatus which can determine a sound source position with a simple configuration and allows a surveillant to find a sound source position easily even if the sound source is located outside the display range of a display device by displaying a direction of the sound source on the display device.

What is claimed is:

1. A display system for displaying a sound source, comprising:
a microphone array configured to pick up a sound of the sound source;
a display device;
a memory that stores instructions; and
a processor that, when executing the instructions stored in the memory, performs a process, wherein the process including:
processing a signal of the sound of the sound source picked up by the microphone array;
visualizing the sound of the sound source picked up by the microphone array;
determining a position of the sound source using data of the visualized sound of the sound source;
generating an image indicating the position of the sound source; and
displaying a direction of the position of the sound source on the display device when the position of the sound source indicated by the image is located outside a display range of the display device.

2. The display system according to claim 1, wherein the process further including:
displaying the direction of the position of the sound source in the display range of the display device.

3. The display system according to claim 1, wherein the process further including:
displaying the direction of the position of the sound source at an end portion of the display range of the display device.

4. The display system according to claim 1, wherein the process further including:
displaying the direction of the position of the sound source on an edge portion of the display device.

5. The display system according to claim 1, wherein the process further including:
determining a position of the sound source only when a sound pressure of the sound picked up by the microphone array is greater than a prescribed threshold value.

6. The display system according to claim 1, wherein the process further including:
determining a position of the sound source only when recognizing that the sound picked up by the microphone array is a human voice.

7. The display system according to claim 2, further comprising:
a camera configured to take an image,
wherein the process further including:
generating a display image in which the image indicating the position of the sound source is superimposed on the image taken by the camera and displaying the display image on the display device.

8. The display system according to claim 7, wherein the camera is rotated automatically toward a direction as to shoot the sound source when the position of the sound source is located outside the display range of the display device.

9. A display method comprising:
processing a signal of a sound of a sound source picked up by a microphone array;
visualizing the sound of the sound source based on the signal of the sound;
determining a position of the sound source using data of the visualized sound of the sound source;
generating an image indicating the position of the sound source; and
displaying a direction of the position of the sound source on a display device when the position of the sound source indicated by the image is located outside a display range of the display device.
